(19) United States
(12) Patent Application Publication
(10) Pub. No.: US 2026/0009268 A1
(43) Pub. Date: Jan. 8, 2026

(54) Flush Door Handle, Vehicle Comprising Same, and Control Method for Vehicle

(71) Applicant: Illinois Tool Works Inc., Glenview, IL (US)

(72) Inventor: Bin Chen, Shanghai (CN)

(21) Appl. No.: 19/260,786

(22) Filed: Jul. 7, 2025

(30) Foreign Application Priority Data
Jun. 30, 2025 (CN) 2025109002617
Jul. 5, 2024 (CN) 202410905797.3

(51) Int. Cl. E05B 85/10; B60R 16/033; E05B 85/16

(52) U.S. Cl. CPC E05B 85/107; B60R 16/033; E05B 85/16

(57) ABSTRACT

The present disclosure discloses a flush door handle, which comprises a driving device, a handle body, an elastic component, and an electromagnetic device. The flush door handle of the present disclosure can electrically drive the handle body to move between the flush position and the deployed position by means of the driving device. Moreover, the handle body can be released and driven to move to the deployed position when the vehicle is in an abnormal state, for example, when the vehicle is powered off or has a failed driving device, to provide an accommodating space into which an operator may insert his/her hand to open the vehicle door by pulling the handle body, and accordingly the safety and the reliability of the flush door handle are improved.

### RELATED APPLICATIONS

The present application claims the benefit of Chinese Patent Application Nos. 202410905797.3, filed July 5, 2024, and 2025109002617, filed June 30, 2025, each titled "Flush Door Handle, Vehicle Comprising Same, and Control Method for Vehicle," the contents of which are hereby incorporated by reference.

### TECHNICAL FIELD

The present disclosure relates to a vehicle door handle, and in particular to a flush door handle for a vehicle, a vehicle comprising the same, and a control method for the vehicle.

### BACKGROUND

In some vehicles, door sheet metal is provided with a flush door handle, and a handle body of the flush door handle has a flush state and a deployed state. When there is no need to use the handle body, the handle body is in the flush state, and an outer surface of the handle body is substantially flush with the door sheet metal to visually hide the handle body. When there is a need to use the handle body, the handle body is in the deployed state to expose a portion to be operated by the hand of a user, for example, to unlock and open a vehicle door by pulling the handle body.

### SUMMARY

The present disclosure relates generally to a flush door handle, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

Fig. 1A is a structural schematic view of a flush door handle in a state according to an embodiment of the present disclosure, with a push rod retracted and the handle body in a flush position.

FIG. 1B is a structural schematic view of the flush door handle shown in Fig. 1A in another state, with the push rod extending out and the handle body in a deployed position.

Fig. 1C. is a structural schematic view of the flush door handle shown in Fig. 1A in another state, with the push rod retracted and the handle body in the deployed position.

Fig. 2A is a structural schematic view of a vehicle comprising the flush door handle in Fig. 1A..

FIG. 2B is a block diagram of a control circuit in FIG. 2A.

Fig. 2C is a block diagram of an exemplary embodiment of the control circuit shown in Fig. 2B .

FIG. 2D is a block diagram of another exemplary embodiment of the control circuit diagram shown in FIG. 2B.

Fig. 4 is a control flow chart of a vehicle in Fig. 2A

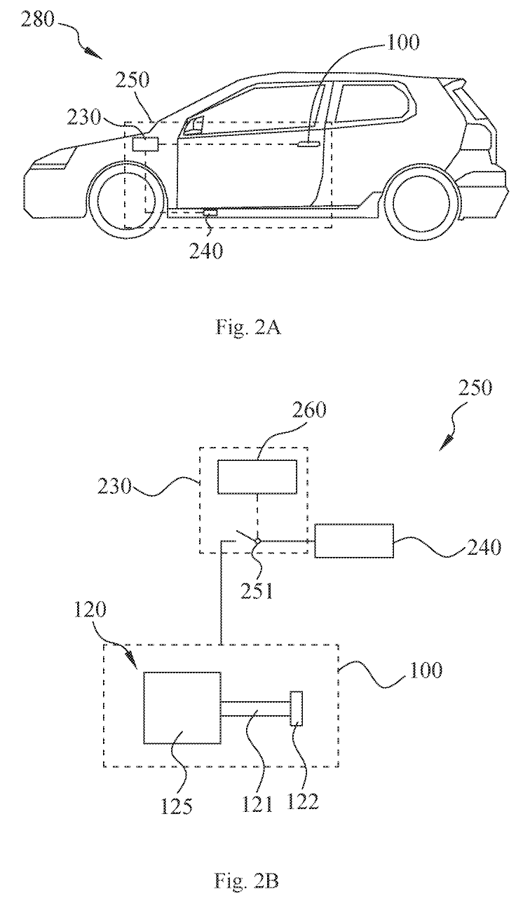

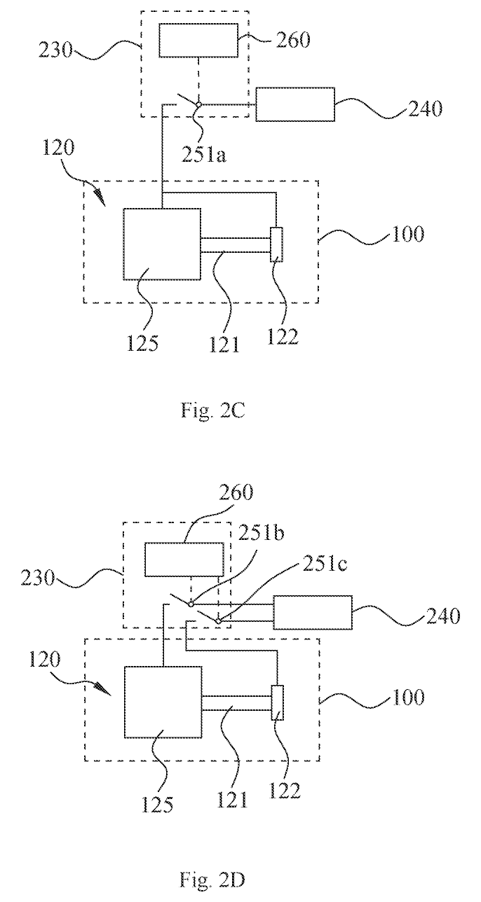

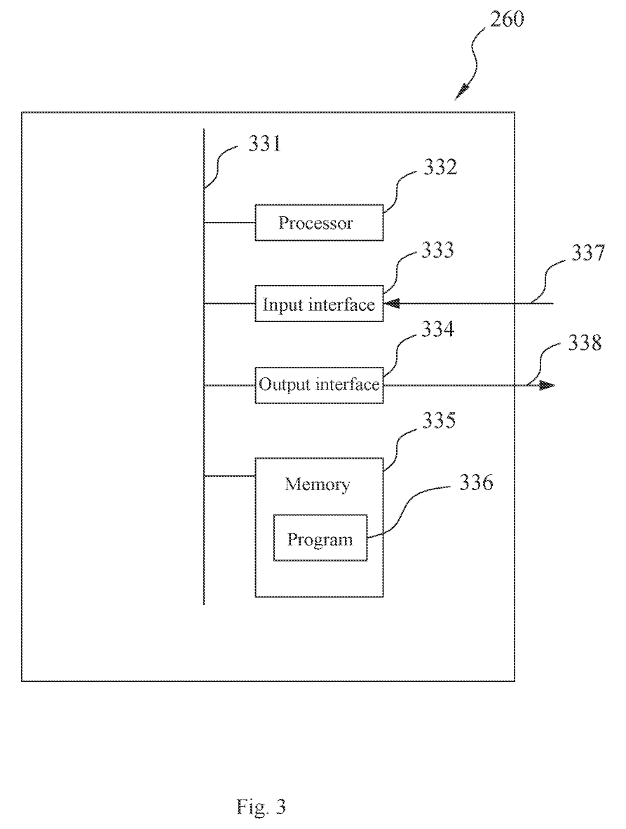

FIG. 3 is a structural block diagram of a controller in FIG. 2B.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as "first," "second," "top," "bottom," "side," "front," "back," and the like are words of convenience and are not to be construed as limiting terms. For example, while in some examples a first side is located adjacent or near a second side, the terms "first side" and "second side" do not imply any specific order in which the sides are ordered.

The terms "about," "approximately," "substantially," or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language ("e.g.," "such as," or the like) provided herein, is intended merely to better illuminate the disclosed examples and does not pose a limitation on the scope of the disclosure. The terms "e.g.," and "for example" set off lists of one or more non-limiting examples, instances, or illustrations. No language in the specification should be construed as indicating any unclaimed element as essential to the practice of the disclosed examples.

The term "and/or" means any one or more of the items in the list joined by "and/or." As an example, "x and/or y" means any element of the three-element set {(x), (y), (x, y)}. In other words, "x and/or y" means "one or both of x and y". As another example, "x, y, and/or z" means any element of the seven-element set {(x), (y), (z), (x, y), (x, z), (y, z), (x, y, z)}. In other words, "x, y, and/or z" means "one or more of x, y, and z."

It has been found that a flush door handle may not be able to be deployed automatically from a flush state to a deployed state when a vehicle is in an abnormal state, for example, when the vehicle is powered off or has a failed driving device.

To at least partially solve the above technical problem, according to a first aspect of the present disclosure, the present disclosure provides a flush door handle, which comprises a driving device, a handle body, an elastic component, and an electromagnetic device. The handle body has a flush position and a deployed position, and is movable between the flush position and the deployed position under the drive of the driving device. The elastic component is configured to provide the handle body with a pretension force for moving the handle body toward the deployed position. The electromagnetic device is configured in such a way that the electromagnetic device attracts, when energized, the handle body such that the handle body is subjected to an acting force opposite to the pretension force, to prevent the pretension force from moving the handle body toward the deployed position; and that the electromagnetic device releases, when deenergized, the handle body such that the handle body is moved to the deployed position under the action of the pretension force of the elastic component.

In some embodiments, the driving device comprises an output end. The electromagnetic device is disposed on one of the output end of the driving device and the handle body. The flush door handle further comprises an attracted portion, the attracted portion is disposed on the other of the output end of the driving device and the handle body. Wherein the electromagnetic device attracts the attracted portion when energized, and is separated from the attracted portion when deenergized. And wherein when the electromagnetic device attracts the attracted portion, the handle body is magnetically engaged with the output end of the driving device such that the handle body is movable between the flush position and the deployed position under the drive of the driving device, and when the electromagnetic device is separated from the attracted portion, the handle body is disengaged from the output end of the driving device such that the handle body is movable to the deployed position under the action of the pretension force of the elastic component.

In some embodiments, the output end of the driving device comprises a push rod, the push rod is capable of extending or retracting. Wherein the handle body is configured to be driven to the deployed position or the flush position respectively during the extension or retraction of the push rod.

In some embodiments, the handle body further comprises a driven portion, the driven portion is magnetically engagable with the push rod when the electromagnetic device is energized, and is disengagable from the push rod when the electromagnetic device is deenergized.

In some embodiments, the electromagnetic device is disposed on the push rod, and the attracted portion is disposed on the driven portion of the handle body.

In some embodiments, the electromagnetic device is disposed on the driven portion of the handle body, and the attracted portion is disposed on the push rod.

In some embodiments, the attracted portion is made of a ferromagnetic material.

In some embodiments, the electromagnetic device is controllably connected to a power supply system of the vehicle so as to be energized or deenergized.

According to a second aspect of the present disclosure, the present disclosure provides a vehicle, which comprises a power supply system, a control device and a flush door handle of anyone of the first aspect of the present disclosure. Wherein the control device is configured to electrically connect the power supply system and the electromagnetic device in a controllable manner to energize or deenergize the electromagnetic device.

In some embodiments, the power supply system is a system for supplying power to the driving device.

According to a third aspect of the present disclosure, the present disclosure provides a control method for a vehicle of the second aspect of the present disclosure, which comprises the following steps: receiving an abnormality signal indicating an abnormal state of the vehicle; and deenergizing the electromagnetic device in response to the abnormality signal to release the handle body, whereby the handle body is moved to a deployed position thereof under the action of a pretension force of the elastic component.

In some embodiments, deenergizing the electromagnetic device comprises: shutting down the power supply system of the vehicle or electrically disconnecting the power supply system from the electromagnetic device.

The flush door handle of the present disclosure can move between the flush position and the deployed position by means of the driving device electrically driving the handle body. Moreover, the handle body can be released and driven to move to the deployed position when the vehicle is in an abnormal state, for example, when the vehicle is powered off or has a failed driving device, to provide an accommodating space into which an operator may insert his/her hand to open the vehicle door by pulling the handle body, and accordingly the safety and the reliability of the flush door handle are improved.

Other objectives and advantages of the present disclosure will be apparent from the following description of the present disclosure with reference to the drawings, which can contribute to a comprehensive understanding of the present disclosure.

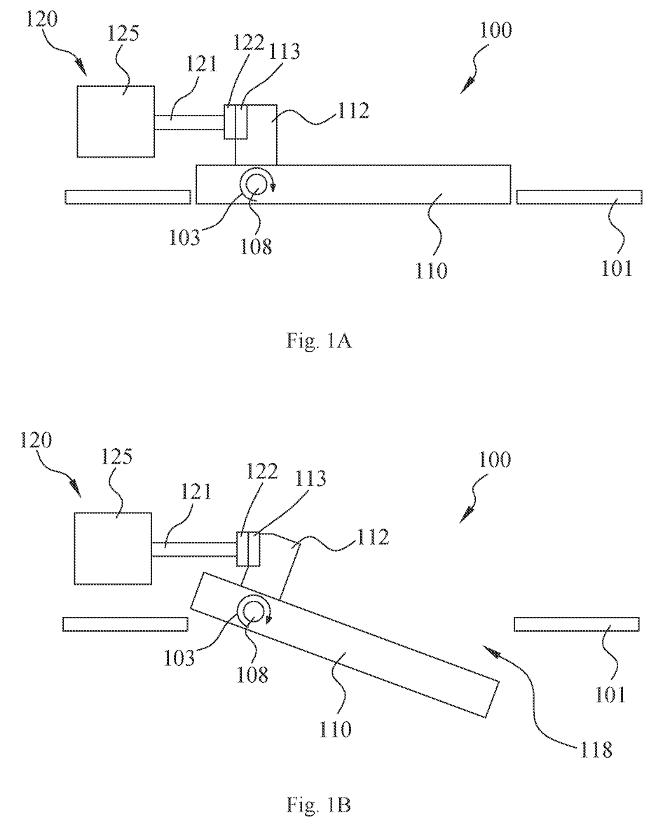

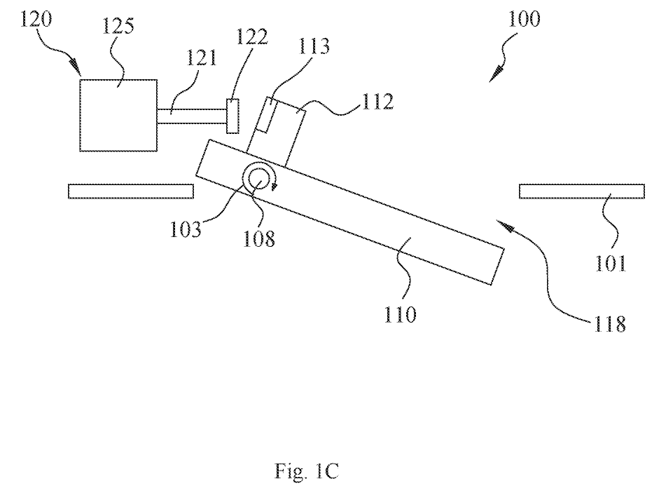

Figs. 1A-1C show structural schematic views of a flush door handle 100 in three different states according to an embodiment of the present disclosure. Fig. 1A shows the flush door handle 100 in a state where a push rod is retracted and a handle body is in a flush position. FIG. 1B shows the flush door handle 100 in a state where the push rod extends out and the handle body is in a deployed position. FIG. 1 C shows the flush door handle 100 in a state where the push rod is retracted and the handle body is in the deployed position. As shown in Figs. 1A-1C, the flush door handle 100 includes the handle body 110 and a driving device 120.

The handle body 110 is movably mounted to door sheet metal 101. The handle body 110 has the flush position and the deployed position, and the handle body 110 can be driven by the driving device 120 to move between the flush position and the deployed position. In this embodiment, the handle body 110 is moved around a rotational shaft 108 between the flush position as shown in Fig. lA and the deployed position as shown in FIGS. 1B and 1C. When the handle body 110 is in the flush position shown in Fig. lA, an outer surface of the handle body 110 is substantially flush with the door sheet metal 101. When the handle body 110 is in the deployed position as shown in FIGS. 1B and 1C, the handle body 110 is at an angle to the door sheet metal 101 to form an accommodating space 118 for an operator to insert his/her hand to open a door by pulling the handle body 110.

The driving device 120 includes an output end for driving the handle body 110. In this embodiment, the driving device 120 is an actuator, and the output end includes a push rod 121. The driving device 120 includes an electric motor 125 and the push rod 121. The electric motor 125 can drive the push rod 121 to extend or retract, for example, the push rod 121 can extend out to the position as shown in FIG. 1B or retract to the position as shown in Figs. 1A and 1C. The handle body 110 is configured to be driven to the deployed position or the flush position respectively during the extension or retraction of the push rod 121. In this embodiment, the handle body 110 is provided with a driven portion 112. The driven portion 112 is configured to engage with the push rod 121 of the driving device 120, such that the push rod 121 of the driving device 120 can push the handle body 110 to move by means of the driven portion 112. In some embodiments, the driven portion 112 further includes a number of transmission assemblies (e.g., rotating mechanism or pushing block ramp mechanism), such that the push rod 121 pushes the handle body 110 to move by means of the transmission assemblies. In some embodiments, transmission assemblies may not be provided on the driven portion 112, but rather between the push rod 121 and the driven portion 112.

The flush door handle 100 further includes an elastic component 103 and an electromagnetic device 122. The elastic component 103 is connected between the rotational shaft 108 and the handle body 110. The elastic component 103 is configured to provide the handle body 110 with a pretension force for moving the handle body 110 toward the deployed position thereof. In this embodiment, the elastic component 103 may be a torsion spring. The electromagnetic device 122 can be magnetized when energized, and lose its magnetism when deenergized. The electromagnetic device 122 is, for example, an electromagnet composed of an iron core and a coil, and can be magnetized when energized.

In this way, when the electromagnetic device 122 is in an energized state, the electromagnetic device 122 attracts the handle body 110 such that the handle body is subjected to an acting force opposite to the pretension force, to prevent the pretension force from moving the handle body 110 toward the deployed position. When the electromagnetic device 122 is in a deenergized state, the electromagnetic device 122 releases the handle body 110. In this case, the electromagnetic device 122 no longer provides the acting force to the handle body 110, so that even if the push rod 121 is retracted, the handle body 110 can still move to the deployed position under the action of the pretension force of the elastic component 103.

In this embodiment, the flush door handle 100 further include an attracted portion 113. In some embodiments, the attracted portion 113 is made of a ferromagnetic material, such as iron, nickel, or cobalt. When the electromagnetic device 122 is energized to be magnetized, the electromagnetic device 122 can attract the attracted portion 113. When the electromagnetic device 122 is deenergized to lose its magnetism, the electromagnetic device 122 can be separated from the attracted portion 113.

In this embodiment, the electromagnetic device 122 and the attracted portion 113 are disposed on the push rod 121 of the driving device 120 and the driven portion 112 of the handle body 110, respectively. For example, the electromagnetic device 122 is disposed at an end of the push rod 121, and the attracted portion 113 is disposed on the driven portion 112. In this way, when the electromagnetic device 122 attracts the attracted portion 113, the push rod 121 of the driving device 120 is magnetically engaged with the driven portion 112 of the handle body 110, such that the handle body 110 can be moved between the flush position and the deployed position under the drive of the driving device 120. When the electromagnetic device 122 is separated from the attracted portion 113, the handle body 110 is disengaged from the push rod 121 of the driving device 120, and the electromagnetic device 122 releases the handle body 110, such that the handle body 110 can be moved toward the deployed position under the action of the pretension force of the elastic component 103. Those skilled in the art should understand that in other embodiments, it is also possible that the electromagnetic device 122 is disposed on the handle body 110, and the attracted portion 113 is correspondingly disposed on the push rod 121. Those skilled in the art should understand that in some other embodiments, according to a specific structure of the handle body, it is also possible that the whole handle body is made of a ferromagnetic material to integrally form the attracted portion, or that a plurality of parts of the handle body are provided with a plurality of attracted portions.

In the embodiment of the present disclosure, in the state shown in Fig. lA, the electromagnetic device 122 is in the energized state, and the electromagnetic device 122 attracts the driven portion 112 of the handle body 110. The push rod 121 of the driving device 120 of the flush door handle 100 is retracted, the handle body 110 overcomes the pretension force of the elastic component 103, such that the handle body 110 is in the flush position.

In the state shown in FIG. 1B, the electromagnetic device 122 is in the energized state, and the electromagnetic device 122 attracts the driven portion 112 of the handle body 110. The push rod 121 of the driving device 120 of the flush door handle 100 extends out, and the handle

body 110 is pushed by the pretension force of the elastic component 103 and by the push rod 121, such that the handle body 110 is in the deployed position.

In the state as shown in FIG. 1C, the electromagnetic device 122 is in the deenergized state, and the electromagnetic device 122 releases the driven portion 112 of the handle body 110. The push rod 121 of the driving device 120 of the flush door handle 100 no longer attracts the handle body 110, and the handle body 110 is subjected to the pretension force of the elastic component 103, such that the handle body 110 is in the deployed position.

That is, when the electromagnetic device 122 is energized, the driving device 120 can drive the handle body 110 to move to the flush position and the deployed position by means of the retraction and extension of the push rod 121. When the electromagnetic device 122 is deenergized, the handle body 110 is no longer pushed by the push rod 121, but is directly moved to the deployed position under the action of the elastic component 103.

Those skilled in the art should understand that in other embodiments, it is also possible that the handle body 110 is moved between the flush position and the deployed position by means of a linear motion or other motions instead of the rotational motion, provided that a corresponding elastic component is disposed. In addition, it is also possible that the driving device 120 includes an output end that performs other types of motion instead of the push rod that performs the linear motion, as long as the handle body 110 can be driven to move, and the electromagnetic device 122 or the attracted portion 113 is correspondingly disposed at an end of a corresponding actuating component.

FIGS. 2A-2D show the structure of a control circuit 250 for controlling the flush door handle 100. FIG. 2A is a structural schematic view of a vehicle 280 including the flush door handle 100 in FIG. 1A. FIG. 2B is a block diagram of the control circuit 250 in FIG. 2A. FIG. 2C shows a specific embodiment of the control circuit 250 shown in FIG. 2B. FIG. 2D shows another specific embodiment of the control circuit 250 shown in FIG. 2B.

As shown in FIG. 2A, the vehicle 280 includes the control circuit 250. The control circuit 250 includes a power supply system 240, a control device 230 and the flush door handle 100. The control device 230 electrically connects the power supply system 240 and the flush door

handle 100 in a controllable manner to control the energization or deenergization of the components of the flush door handle 100. In this embodiment, the power supply system 240 is a power battery system of the vehicle 280 or other systems capable of supplying power, for example, a battery management system (BMS).

As shown in FIG. 2B, the control device 230 controllably connects the power supply system 240 and the electromagnetic device 122, to control the energization or deenergization of the electromagnetic device 122. Moreover, the control device 230 further electrically connects the power supply system 240 and the driving device 120 in a controllable manner, to control the energization or deenergization of the electric motor 125 of the driving device 120 and to control the extension or retraction of the push rod 121 by controlling the electric motor 125.

As an example, the control device 230 includes a controller 260 and a switching device 251. The switching device 251 is connected between the flush door handle 100 and the power supply system 240, and the controller 260 controls whether the driving device 120 and the electromagnetic device 122 of the flush door handle 100 are electrically connected to the power supply system 240 by controlling the opening or closing of the switching device 251, and accordingly controls the energization or deenergization of the driving device 120 and the electromagnetic device 122. In some embodiments, it is also possible that the control device 230 controls the energization or deenergization of the driving device 120 and the electromagnetic device 122 in other manners, for example, directly controls the turning on or turning off of the power supply system 240.

As a more specific example, as shown in FIG. 2C, the control device 230 includes a controller 260 and one switching device 251 a. The electric motor 125 of the driving device 120 and the electromagnetic device 122 are electrically connected to the power supply system 240 by means of the common switching device 251a, such that the control device 230 controls the energization and deenergization of the electric motor 125 and the electromagnetic device 122 simultaneously.

As another specific example, as shown in FIG. 2D, the control device 230 includes a controller 260 and two switching devices. The two switching devices include a switching device 251b and a switching device 251c. The electric motor 125 and the electromagnetic device 122 are electrically connected to the power supply system 240 respectively by means of the switching device 251b and the switching device 251c, such that the control device 230 controls the energization or deenergization of the electric motor 125 and the electromagnetic device 122 separately.

In this way, depending on the specific structure of the control circuit 250, the control device 230 can either control the electric motor 125 and the electromagnetic device 122 simultaneously, or control the electric motor 125 and the electromagnetic device 122 separately. In some embodiments, it is also possible that the control device 230 controls the extension or retraction of the push rod 121 separately. In some embodiments, when the electromagnetic device 122 is disposed on the driven portion 112 of the handle body 110, the electromagnetic device 122 on the driven portion 112 is electrically connected to the control device 230 by means of a wire harness.

FIG. 3 shows a structural block diagram of the controller 260. As shown in FIG. 3, the controller 260 includes a bus 331, a processor 332, an input interface 333, an output interface 334, and a memory 335 storing a program 336. The components of the controller 260, including the processor 332, the input interface 333, the output interface 334 and the memory 335, are communicatively connected to the bus 331, so that the processor 332 can control operations of the input interface 333, the output interface 334 and the memory 335. Specifically, the memory 335 is configured to store programs, instructions and data, and the processor 332 reads the programs, instructions and data from the memory 335 and can write data into the memory 335. The processor 332 controls the operations of the input interface 333 and the output interface 334 by means of executing the programs and the instructions read from the memory 335.

As shown in FIG. 3, the input interface 333 is communicatively connected to various sensors of the vehicle and various input commands by means of a connection 337, to receive various parameters such as state parameters of the vehicle or input parameters operated by the operator, and to store these parameters into the memory 335. The output interface 334 is communicatively connected to the switching device 251 by means of a connection 338. By executing the program 336 in the memory 335, the controller 260 controls the opening or closing of the switching device 251, so that the control device 230 can control the connection or disconnection between the power supply system 240 and the electric motor 125 and/or the electromagnetic device 122.

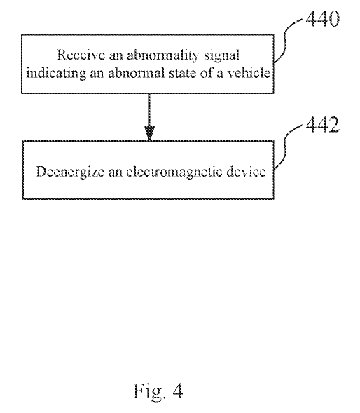

FIG. 4 shows a control flow chart of the vehicle. When the vehicle is operating, the control device 230 receives a signal about the state of the vehicle. When the control device 230 receives an abnormality signal as shown in step 440, indicating that the state of the vehicle is abnormal (for example, a vehicle crash resulting in a power failure of the vehicle, or a failure of the driving device and so on), step 441 is executed.

In step 441, the control device 230 deenergizes the electromagnetic device 122 in response to the abnormality signal, such that the handle body 110 is released, so as to move the handle body 110 to the deployed position thereof under the action of the pretension force of the elastic component 103.

In some embodiments, the control device 230 deenergizing the electromagnetic device 122 includes shutting down the power supply system 240 of the vehicle or electrically disconnecting the power supply system 240 from the electromagnetic device 122.

In some embodiments, in response to the abnormality signal, the control device 230 also shuts down the power supply system 240 if the power supply system 240 of the vehicle does not stop operating.

Therefore, when the vehicle is in the abnormal state, no matter whether the push rod 121 is in an extended state or in a retracted state, as long as the control device 230 controls the deenergization of the electromagnetic device 122, the handle body 110 can be moved immediately to the deployed position thereof for a manual operation by the operator.

The flush door handle of the present disclosure can electrically drive the handle body to move between the flush position and the deployed position by means of the driving device. Moreover, the handle body can be released and driven to move to the deployed position when the vehicle is in an abnormal state, for example, when the vehicle is powered off or has a failed driving device, to provide an accommodating space into which an operator may insert his/her hand to open the vehicle door by pulling the handle body, and accordingly the safety and the reliability of the flush door handle are improved.

Furthermore, the handle body of the flush door handle of the present disclosure is deployed immediately when the vehicle is powered off or the control system controls the deenergization of the electromagnetic device, without the need for any additional action of the control device, the handle body is more rapidly deployed, and a sufficient deployment angle of the handle body can be ensured.

In addition, the flush door handle of the present disclosure only needs to be electrically connected to one power supply system, without the need for any additional redundant power supply to operate the driving device, so that reliable deployment of the flush door handle is ensured, redundant power supply is saved, and costs are reduced.

Although the present disclosure is described with respect to the examples of embodiments outlined above, various alternatives, modifications, variations, improvements, and/or substantial equivalents that are known or current or to be anticipated before long may be obvious to those of at least ordinary skill in the art. In addition, the technical effects and/or technical problems described in this specification are exemplary rather than limiting; therefore, the disclosure in this specification may be used to solve other technical problems and have other technical effects and/or may solve other technical problems. Accordingly, the examples of the embodiments of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or basic equivalents.

### List of reference signs:

Flush Door Handle 100

Door Sheet Metal 101

Elastic Component 103

Rotational Shaft 108

Handle Body 110

Driven Portion 112

Attracted Portion 113

Accommodating Space 118

Driving Device 120

Push Rod 121

Electromagnetic Device 122

Electric Motor 125

Control Device 230

Power Supply System 240

Control Circuit 250

Switching Device 251/251a/251b/251c

Controller 260

Vehicle 280

Bus 331

Processor 332

Input Interface 333

Output Interface 334

Memory 335

Program 336

Connection 337

Connection 338.

What is claimed is:

1. A flush door handle, comprising: a driving device; a handle body, the handle body having a flush position and a deployed position,
and being movable between the flush position and the deployed position under the drive of the driving device; an elastic component, the elastic component being configured to provide the handle body with a pretension force for moving the handle body toward the deployed position;
and an electromagnetic device, the electromagnetic device being configured in such a way that the electromagnetic device attracts, when energized, the handle body such that the handle body is subjected to an acting force opposite to the pretension force, to prevent the pretension force from moving the handle body toward the deployed position; and that the electromagnetic device releases, when deenergized, the handle body such that the handle body is moved to the deployed position under the action of the pretension force of the elastic component.

2. The flush door handle according to claim 1, wherein the driving device comprises an output end; the electromagnetic device is disposed on one of the output end of the driving device and the handle body; and the flush door handle further comprises an attracted portion, the attracted portion being disposed on the other of the output end of the driving device and the handle body, wherein the electromagnetic device attracts the attracted portion when energized, and is separated from the attracted portion when deenergized; and wherein when the electromagnetic device attracts the attracted portion, the handle body is magnetically engaged with the output end of the driving device such that the handle body is movable between the flush position and the deployed position under the drive of the driving device, and when the electromagnetic device is separated from the attracted portion, the handle body is disengaged from the
output end of the driving device such that the handle body is movable to the deployed position under the action of the pretension force of the elastic component.

3. The flush door handle according to claim 2, wherein the output end of the driving device comprises a push rod, the push rod being capable of extending or retracting, and wherein the handle body is configured to be driven to the deployed position or the flush position respectively during the extension or retraction of the push rod.

4. The flush door handle according to claim 3, wherein the handle body further comprises a driven portion, the driven portion being magnetically engagable with the push rod when the electromagnetic device is energized, and being disengagable from the push rod when the electromagnetic device is deenergized.

5. The flush door handle according to claim 4, wherein the electromagnetic device is disposed on the push rod, and the attracted portion is disposed on the driven portion of the handle body.

6. The flush door handle according to claim 4, wherein the electromagnetic device is disposed on the driven portion of the handle body, and the attracted portion is disposed on the push rod.

7. The flush door handle according to claim 5, wherein the attracted portion is made of a ferromagnetic material.

8. The flush door handle according to claim 1, wherein the electromagnetic device is controllably connected to a power supply system of the vehicle so as to be energized or deenergized.

9. A vehicle, comprising: a power supply system; a control device; and a flush door handle according toa flush door handle according to
wherein the control device is configured to electrically connect the power supply system and the electromagnetic device in a controllable manner to energize or deenergize the electromagnetic device.

10. The vehicle according to claim 9, wherein the power supply system is a system for supplying power to the driving device.

11. A control method for a vehicle of claim 9, comprising: receiving an abnormality signal indicating an abnormal state of the vehicle; and deenergizing the electromagnetic device in response to the abnormality signal to release the handle body, whereby the handle body is moved to a deployed position thereof under the action of a pretension force of the elastic component.

12. The control method according to claim 11, wherein deenergizing the electromagnetic device comprises: shutting down the power supply system of the vehicle or electrically disconnecting the power supply system from the electromagnetic device.
